(19) United States
(12) Patent Application Publication
(10) Pub. No.: US 2011/0295955 A1
(43) Pub. Date: Dec. 1, 2011

(54) PAGE MONITORING

(75) Inventor: Esa-Matti Runola, Klaukkala (FI)

(73) Assignee: IP NETWORKS OY, Espoo (FI)

(21) Appl. No.: 12/739,751

(22) PCT Filed: Oct. 22, 2008
(86) PCT No.: PCT/FI2008/050589

§ 371 Date: Aug. 13, 2010

(30) Foreign Application Priority Data
Oct. 24, 2007 (FI) 20075751

(51) Int. Cl. G06F 15/16

(52) U.S. Cl. 709/206

(57) ABSTRACT

An apparatus (1) for monitoring a page (7) maintained on a communications network (2). In order to detect changes, the apparatus includes: a download unit configured to receive the page to be monitored via the communications network, to produce a graphic presentation of the received page, and to select from the graphic presentation a desired picture area (8) for comparison, a memory for storing a reference picture which indicates what the selected picture area of the graphic presentation of the page (7) to be monitored looked like previously, and a comparison unit which compares the selected picture area (13) with the reference picture stored in the memory and which, in response to detection of a difference, indicates a change.

### FIELD OF THE INVENTION

The present invention relates to monitoring a page maintained on a communications network. The invention is suitable to be utilized for detecting changes in a WWW (World Wide Web) page maintained on the Internet, for instance.

### DESCRIPTION OF THE PRIOR ART

In certain situations it may be necessary to monitor a page maintained on a communications network. In the present context, the concept “a page maintained on a communications network” refers to a page which is maintained by an apparatus connected to a communications network in a way to enable the particular page to be downloaded to another apparatus via the particular communications network. Such a page may be e.g. a page maintained on a server which releases interesting news, when information about newly released news is wanted as soon as possible.

Presently, however, no satisfying solution exists for implementing such monitoring.

### SUMMARY OF THE INVENTION

An object of the present invention is to solve the aforementioned problem and to provide a novel solution for efficiently monitoring a page maintained on a communications network. This object is achieved by an apparatus according to independent claim 1, a method according to independent claim 5, computer software according to independent claim 8, and a storage medium according to independent claim 9.

In the invention, the page to be monitored is received from the communications network and a graphic presentation is produced thereof. From the graphic presentation, a desired picture area, i.e. the very part of the page whose possible changes are of interest, is selected for comparison. Next, the picture area in graphic format is compared with a reference picture which indicates what the particular picture area looked like previously. If in the comparison it is detected that the selected picture area does not correspond with the reference picture, the page to be monitored has changed. In such a case, a message indicating this is transmitted to a predetermined receiver.

The solution according to the invention thus enables the monitoring to be automated such that information is obtained about a change occurred in an interesting picture area of the page to be monitored.

Preferred embodiments of the apparatus and method according to the invention are disclosed in the attached dependent claims.

### BRIEF DESCRIPTION OF THE FIGURES

In the following, the invention will be described in closer detail by way of example and with reference to the accompanying drawings, in which:

FIG. 1 shows a flow diagram of a first embodiment of the invention,

FIGS. 2 and 3 illustrate an embodiment of an apparatus according to the invention, and

FIG. 4 illustrates another embodiment of the apparatus according to the invention.

### DESCRIPTION OF AT LEAST ONE EMBODIMENT

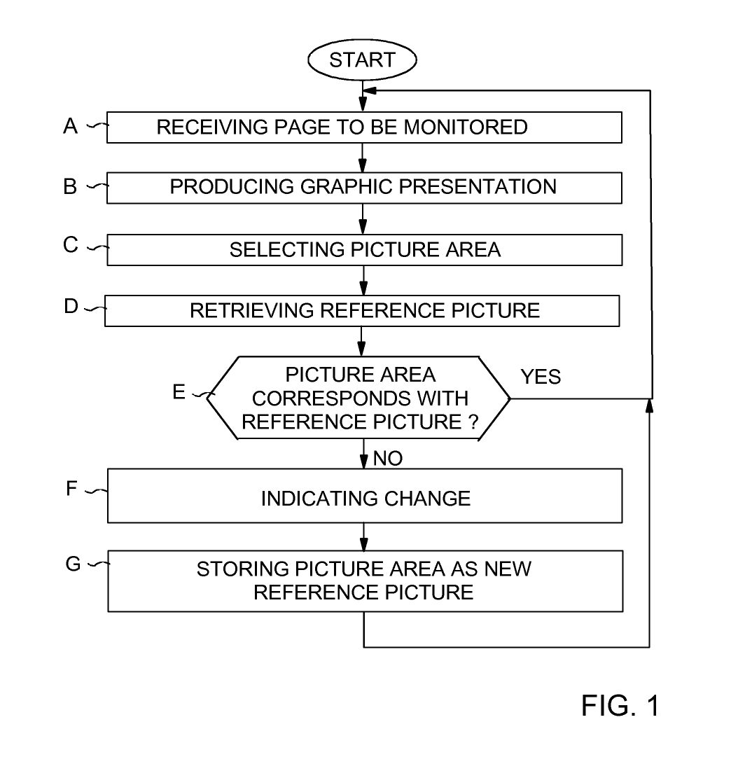

FIG. 1 shows a flow diagram of a first preferred embodiment of the invention. The embodiment of FIG. 1 is suitable to be utilized in monitoring WWW (World Wide Web), WAP (Wireless Application Protocol) or XHTML (Extensible HyperText Markup Language) pages, for instance. In the following, it is by way of example assumed that the pages to be monitored are WWW pages. The service may be utilized e.g. by advertisers, who pay the maintainer of the page to be monitored for showing their advertisement and who, consequently, wish to know when the advertisement is removed from the page. Alternatively, the service may be utilized e.g. by companies wishing to survey press releases given by competitors such that information about new press releases is immediately received by those responsible for the companies' competitor surveillance.

In block A, a page to be monitored is received. The page may be a page which is maintained in a format wherein the page consists of a plurality of elements. An example of such a page is a WWW page maintained on the Internet which is stored on a server connected to the Internet in an HTML (HyperText Markup Language) format. A page stored in the HTML format may include e.g. text and picture elements separate from one another and elements affecting the design of the page, which together define the way in which the page in question is to be presented graphically.

An alternative for retrieving a page to be monitored by means of a computer utilizing a UNIX operating system is to retrieve the page by a WGET program. This program is an Open Source program which enables the data of the page to be retrieved and stored in memory of the computer being used, e.g. on a hard disk. When the page is a page in the HTML format, an HTML data file in text format as well as other data files necessary for the graphic presentation of the page are in practice stored in the memory.

In block B, a graphic presentation of the retrieved page is produced. This may in practice take place by software which, in a manner similar to that employed by a browser program for browsing the Internet, generates a graphic picture on the basis of the elements contained in the page.

An alternative for producing a graphic presentation is to utilize a KONQUEROR program. This program is an Open Source browser program which is capable of reading e.g. an HTML data file stored on the hard disk of a computer and, on the basis of this, producing a graphic presentation of the page.

In block C, a picture area is selected from the graphic presentation of the page. The picture area may be selected e.g. by an IMPORT program. This program is an Open Source program which copies the picture area selected from the graphic presentation, which it e.g. stores as a picture file on the hard disk of the computer.

According to the invention, when monitoring begins, a picture area to be selected is defined for the apparatus to be used in the monitoring e.g. by defining the coordinates of the particular picture area. This enables the apparatus to utilize, during monitoring, these coordinates in connection with the selection of the picture area.

In blocks D and E, it is checked whether the selected picture area is different from a reference picture. A picture file stored on the hard disk of the apparatus being used is used as the reference picture which indicates what the selected picture area of the graphic presentation of the page to be monitored looked like previously.

After the selected picture area has been stored in the data file on the hard disk, the comparison with the reference picture may be carried out e.g. by a DIFF command contained in the UNIX operating system. This makes it possible to establish, in block E, whether or not the selected picture area corresponds with the reference picture. If the selected picture area corresponds with the reference picture, the process returns to block A.

If, in contrast, it is found out in block E that the selected picture area does not correspond with the reference picture, a change is indicated in block F. The change may be indicated by storing information indicating the change in memory wherein the information is available to a provider of or a subscriber to (a client of the service provider) the service. Alternatively, the change may be indicated by transmitting a message indicating the change to a predetermined receiver, such as the provider of or the subscriber to the service. In practice, this may be implemented in a plurality of alternative ways. An alternative is to trigger sending of an e-mail to a predetermined receiver, so that the receiver of the e-mail becomes aware of the page to be monitored being changed in an interesting manner. Alternatively, sending of a message to a mobile terminal of a mobile communication system may be triggered, so that the receiver, irrespective of location, receives the information on his or her mobile terminal. The message may be an SMS (Short Message Service) message sent to a telephone in a GSM (Global System for Mobile communications) system, for instance.

The method step of block G is not necessary. If the purpose is to monitor the page only until a first change is detected therein, the monitoring ends after block F. However, in some embodiments it may be advantageous to continue monitoring also after the first detected change. In such a case, in block G the selected picture area is stored as a new reference picture. This enables the reference picture to be updated, and from now on comparison may be carried out with this new reference picture. In the continuing monitoring the process returns via block G to block A. Depending on the implementation, the page to be monitored may be retrieved next time immediately or e.g. after a certain delay. If more than one page to be monitored exists, the pages in question may be run through alternately as a continuous process without pauses.

The method shown by the flow diagram of FIG. 1 may be readily automated to be implemented e.g. by a computer which, controlled by software installed thereon, performs the procedures described in connection with the blocks of the flow diagram.

Above in relation to the flow diagram of FIG. 1 it has been shown that once the page to be monitored has been received, the production of a graphic presentation of the page is started so as to enable the selected picture area to be compared with the reference picture (e.g. by comparing graphic data files, such as bitmaps). However, as distinct from this, it is feasible that in some embodiments no comparison between pictures is carried out directly. For this purpose, in addition to the reference picture, the entire retrieved page including its attachment files in text format, e.g. in HTML format, may be provided in the memory of the apparatus used for monitoring. This page provided in the memory may thus be compared with the retrieved page at the initial stage (after block A). If the stored page including its attachment files in the HTML format corresponds with the HTML format of the retrieved page including its attachment files, this means that no changes have occurred. In such a case, the process may return directly to block A in order to start a new monitoring cycle. An advantage of such a solution is that a need for comparison between the picture area in graphic format and the reference picture is completely avoided. The graphic comparison requires a considerably larger amount of resources from the apparatus being used.

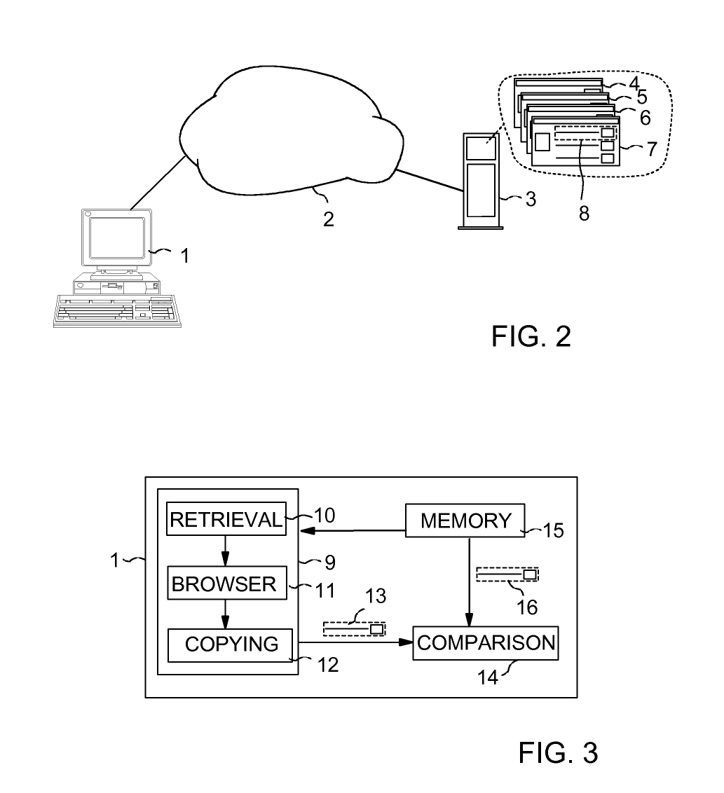

FIGS. 2 and 3 illustrate an embodiment of an apparatus according to the invention. The apparatus of FIGS. 2 and 3 is suitable to be utilized in the method of FIG. 1.

FIG. 2 shows an apparatus 1 enabling, via a communications network 2, a page maintained by a server 3 to be monitored. In the example of FIG. 2, the server maintains a plurality of pages 4 to 7; it is by way of example assumed that it is page 7 in particular that is being monitored. The communications network 2 may be e.g. the Internet and pages 4 to 7 may be WWW pages that are maintained in the HTML format or as FLASH or picture files.

In the presentation of FIG. 3, the apparatus 1 comprises a plurality of units 9 to 12 and 14, each of which being implementable by a circuit solution, computer programs or a combination thereof. An alternative is that the apparatus 1 is a computer which utilizes a UNIX or a LINUX operating system and which, by means of a program or programs stored in memory, implements the functions of the aforementioned units. The number of units does not have to match that shown in FIG. 3, but two or more units may be integrated with one another. The memory 15 may consist e.g. of a central memory, a hard disk of the computer, or a database.

In the case of FIG. 3, a download unit 9 comprises a retrieve unit 10 which, on the basis of information stored in the memory 15, retrieves and receives via the communications network 2 the page 7 to be monitored. Messages may be stored in the memory to be transmitted by the retrieve unit 10 via the communications network 2 in order to be able to receive the page 7 into the apparatus 1.

A browser unit 11 processes the page received by the retrieve unit 10, producing a graphic presentation thereof. It thus becomes possible to combine different elements of the page which initially was e.g. in the HTML format so as to achieve a graphic page with a corresponding outlook which would be produced of the page 7 in question e.g. by an Internet browser for browsing WWW pages.

The copying unit 12 selects from the graphic presentation of the page 7 produced by the browser unit 11 a predetermined picture area for comparison. This may take place e.g. such that coordinates for the picture area to be monitored have been stored in advance in the memory 15. In FIG. 3, it is by way of example assumed that the monitoring is to be focused expressly on the picture area of the page 7 outlined in broken lines 8 containing e.g. a photograph and some text. Information on any changes occurred within this picture area is desired. Consequently, the coordinates of the angle points of this picture area are stored in the memory 15. On the basis of the coordinates, the copying unit thus copies a picture area 13 from the graphic presentation of the page 7.

The comparison unit 14 compares the picture area 13 and the reference picture in the memory 15. The comparison may be comparison between graphic files stored on the hard disk of the apparatus 1. On the basis of the comparison, the comparison unit 14 establishes that the picture area 13 corresponds with the reference picture 16, in which case no change is detected as a result of the monitoring. In this case the monitoring continues. Alternatively, the comparison unit 14 establishes that the picture area 13 does not correspond with the reference picture 16, in which case a change has been detected as a result of the monitoring. In such a case, the comparison unit 14 indicates the change. It may indicate the change e.g. by triggering a sending of a message to a predetermined receiver, e.g. via the communications network 2, or by storing information on the change in a predetermined memory to be used by the provider of or the subscriber to the service.

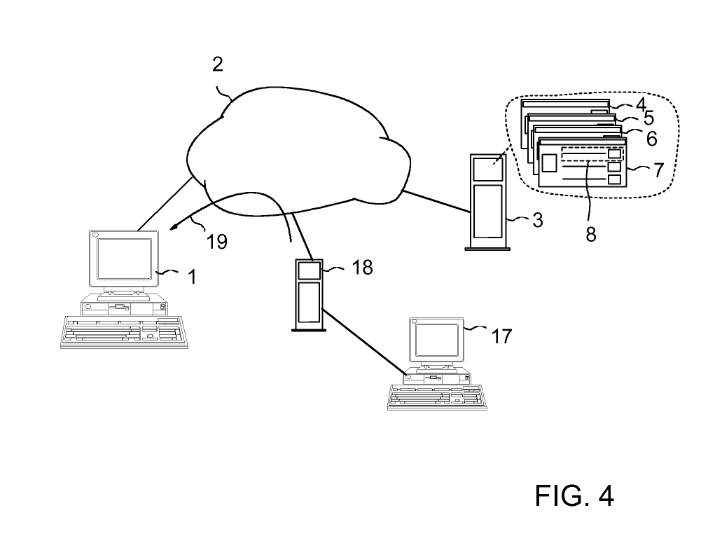

FIG. 4 illustrates a second embodiment of the apparatus according to the invention. The embodiment of FIG. 4 is very similar to the embodiment described in connection with FIGS. 2 and 3; therefore, the embodiment of FIG. 4 will be described in the following mainly by showing differences between these embodiments.

In the case of FIG. 4, the apparatus further comprises a computer 17 and a proxy server 18, via which the computer 17 is connected to the communications network 2. The computer 17 and the proxy server 18 are utilized in the definition of the page 7 to be monitored and the picture area depicted in broken lines 8 in order to enable the apparatus by which the monitoring is implemented to monitor the desired picture area.

Not all pages to be maintained on the communications network 2 are accessible directly by a correct address. It may be that a user first has to go e.g. to a log-on page 4 maintained by the server 3 so as to log on as a user by means of a user name and a password. Only after verification of the user name and the password does the server allow the user to proceed to one of the pages 5, 6, or 7, according to personal choice. This means that the user, by clicking a correct link, has to go to the page 7 of interest, wherein the picture area to be monitored is found. In order to monitor the page 7, it is thus necessary to automate the aforementioned stages so as to enable the apparatus 1 carrying out the monitoring to repeat them automatically while retrieving and receiving, via the communications network 2, the page 7 for its use.

In the embodiment of FIG. 4, the proxy server 18 is configured to record, i.e. store in memory, at least messages to be transmitted from the proxy server 18 to the communications network 2 when the user of the computer 17 manually, using the user interface of the browser program and the computer 17, via the proxy server 18 retrieves the page 7 to the display of the computer 17. In such a case, the address of the page 4, the user name and the password entered by the user, as well as post-logon selections made by the user for selecting the page 7 become stored in the memory of the proxy server 18. According to the invention, it is also feasible that the proxy server 18 records, i.e. stores in memory, also messages transmitted from the communications network 2 to the computer 17 when the page 7 is being retrieved to the display of the computer. In such a case, a copy of the page 7 to be monitored may also be stored in the memory.

The proxy server 18 may be installed with special software enabling the user of the computer 17, after accessing the page 7, to define a picture area whose changes the user wishes to be informed of. This software, via which the downloading of the page 7 to the computer 17 takes place, may add e.g. a grid to the page 7 to be received, on the basis of which the user may, via the computer 17, enter information (identifiers of selected square(s) or coordinates of angle points thereof) to the proxy server 18 to indicate the coordinates of the angle points of the picture area. Alternatively, the software of the proxy server may provide the user with an opportunity to use a mouse for defining the picture area, whereby the software is able to identify the coordinates of the angle points of the picture area on the basis of the area defined by the mouse. Further, the software may provide the user of the computer with an opportunity to enter his or her contact information to indicate e.g. whereto a message is to be sent if in the monitoring it is detected that the page to be monitored has changed.

As described above, a sequence of messages to be transmitted to the telecommunication network, which enables the page 7 to be retrieved, thus becomes stored in the memory of the proxy server 18. In addition, the coordinates of the angle points of the selected picture area as well as e.g. the e-mail address of the user are stored in the memory. Further, the page to be monitored may also be stored in the memory, on the basis of which a reference picture may be produced (by means of the proxy server 18 or the apparatus 1), the reference picture showing what the selected picture area looks like when monitoring is about to be started. In order to start monitoring, this information stored in the memory of the proxy server is transferred to the memory of the apparatus 1 to be utilized in connection with the monitoring. This transfer may take place via the communications network 2, as indicated by arrow 19. Alternatively, the information may be transferred in another way, e.g. by storing them on a storage medium, such as a diskette or a memory circuit, which is taken from the proxy server 18 to the apparatus 1.

Referring to FIG. 4, it has been assumed above by way of example that the apparatus 1 carrying out the monitoring and the proxy server 18 are pieces of hardware separate from one another. However, according to the invention it is also feasible that one apparatus, such as the apparatus 1, performs both the monitoring and the functions that above have been described to be performed by the proxy server 18.

It is to be understood that the above description and the related figures are only intended to illustrate the present invention. It will be apparent to one skilled in the art that the invention may be varied and modified without deviating from the scope of the invention.

1-9. (canceled)

10. An apparatus for monitoring a page maintained on a communications network, said apparatus comprises:
a download unit configured to receive the page to be monitored via the communications network, to produce a graphic presentation of the received page, and to select from the graphic presentation a desired picture area for comparison,
a memory for storing a reference picture which indicates what the selected picture area of the graphic presentation of the page to be monitored looked like previously, and
a comparison unit which compares the selected picture area with the reference picture stored in the memory and which, in response to detection of a difference, indicates a change in the page to be monitored.

11. An apparatus as claimed in claim 10, wherein the comparison unit is configured to store the selected picture area as a reference picture in the memory in response to the detection of a difference.

12. An apparatus as claimed in claim 10, wherein the page is maintained on the communications network in a format wherein a page consists of a plurality of elements, and that the download unit is configured to produce a graphic presentation on the basis of the plurality of elements.

13. An apparatus as claimed in claim 10, wherein the apparatus comprises a proxy server which comprises a memory and which is configured to store in the memory messages transmitted by the proxy server to the communications network when the page to be monitored is retrieved to a computer via the proxy server, and in that the download unit is configured to retrieve the page to be monitored by transmitting the messages stored in the memory of the proxy server to the communications network.

14. A method of monitoring a page maintained on a communications network, comprising:
receiving a page to be monitored from the communications network and producing a graphic presentation of the received page, selecting from the graphic presentation of the page a desired picture area for comparison,
retrieving from a memory a reference picture which indicates what the selected picture area of the graphic presentation of the page to be monitored looked like previously,
comparing the selected picture area with the reference picture for detecting differences, and
indicating a change in the page to be monitored if in the comparison a difference is detected.

15. A method as claimed in claim 14, wherein when in the comparison a difference is detected, storing the selected picture area in a memory for use as a reference picture in subsequent monitoring.

16. A method as claimed in claim 14, wherein in order to start monitoring, retrieving and receiving via a proxy server the page to be monitored to a computer by manually entering commands to the computer via a user interface of the computer, and storing in the memory of the proxy server messages transmitted during retrieval and receipt of the page from the proxy server to the communications network, and
after the monitoring has started, performing the retrieval and receipt of the page to be monitored by transmitting the messages stored in the memory of the proxy server to the communications network.

17. Computer software configured to control a programmable device to:
receive a page to be monitored from a communications network, and produce a graphic presentation of the page, select from the graphic presentation of the page a desired picture area for comparison,
retrieve from a memory a reference picture which indicates what the selected picture area of the graphic presentation of the page to be monitored looked like previously,
compare the selected picture area with the reference picture for detecting differences, and
indicate a change if in the comparison a difference is detected.

18. A computer readable storage medium on which software according to claim 17 is stored.
